(19) United States
(12) Patent Application Publication
(10) Pub. No.: US 2022/0261719 A1
(43) Pub. Date: Aug. 18, 2022

(54) SHARING MANAGEMENT DEVICE, TERMINAL, SHARING MANAGEMENT METHOD, AND RECORDING MEDIUM

(71) Applicant: NEC Corporation, Minato-ku, Tokyo (JP)

(72) Inventor: Akinori INABA, Tokyo (JP)

(73) Assignee: NEC Corporation, Minato-ku, Tokyo (JP)

(21) Appl. No.: 17/625,416

(22) PCT Filed: Jul. 6, 2020
(86) PCT No.: PCT/JP2020/026473

§ 371 Date: Jan. 7, 2022

(30) Foreign Application Priority Data
Jul. 12, 2019 (JP) 2019-130014

(51) Int. Cl. G06Q 10/06

(52) U.S. Cl. CPC G06Q 10/06312

(57) ABSTRACT

From each of a plurality of mobile terminals mounted in moving devices conveying a sharing target object shared by a plurality of users, management information including the number of the sharing target object being conveyed by the moving device and a current position of the moving device are acquired. The management information acquired from each of the plurality of mobile terminals is output.

### TECHNICAL FIELD

The present invention relates to a sharing management device, a terminal, a sharing management method, and a recording medium.

### BACKGROUND ART

Many sharing services for renting objects that are used by sharing the objects among a plurality of users are provided. For example, there are sharing services for renting sharing target objects such as bicycles, mobile terminals, and mobile routers. In such sharing services, storage bases for storing sharing targets object are distributed by being disposed in a plurality of places. A user using a sharing service receives a sharing target object at a certain storage place and returns the sharing target object to the storage base or another storage base. As relating technologies, technologies relating to car sharing have been disclosed in Patent Documents 1 to 4.

### PRIOR ART DOCUMENTS

### Patent Documents

Patent Document 1: Japanese Unexamined Patent Application, First Publication No. 2016-148910

Patent Document 2: Japanese Unexamined Patent Application, First Publication No. 2010-170293

Patent Document 3: Japanese Unexamined Patent Application, First Publication No. 2010-170283

Patent Document 4: Japanese Unexamined Patent Application, First Publication No. 2009-301150

### SUMMARY OF THE INVENTION

### Problem to be Solved by the Invention

In the sharing services as described above, unevenness may occur in the numbers of sharing target objects stored in respective storage bases, and the efforts of a supervisor in moving shared objects from a storage base at which the number of stored objects is excessive to a storage base at which the number of stored objects is insufficient need to be reduced.

One example object of the present invention is to provide a sharing management device, a terminal, a sharing management method, and a recording medium that solve the problems described above.

### Means for Solving the Problem

A sharing management device according to one example aspect of the present invention includes: an acquisition means for acquiring, from each of a plurality of mobile terminals mounted in moving devices conveying a sharing target object shared by a plurality of users, management information including number of the sharing target object being conveyed by the moving device and a current position of the moving device; and a management means for outputting the management information acquired from each of the plurality of mobile terminals.

A terminal according to one example aspect of the present invention is for being mounted in a moving device conveying a sharing target object shared by a plurality of users, and includes: a number detecting means for detecting number of the sharing target object being conveyed by the moving device; a position detecting means for detecting a current position of the moving device; and a transmission means for transmitting management information including the number of the sharing target object and the current position to a sharing management device.

A sharing management method according to one example aspect of the present invention includes: acquiring, from each of a plurality of mobile terminals mounted in moving devices conveying a sharing target object shared by a plurality of users, management information including number of the sharing target object being conveyed by the moving device and a current position of the moving device; and outputting the management information acquired from each of the plurality of mobile terminals.

A recording medium according to one example aspect of the present invention stores a program for causing a computer of a sharing management device to execute: acquiring, from each of a plurality of mobile terminals mounted in moving devices conveying a sharing target object shared by a plurality of users, management information including number of the sharing target object being conveyed by the moving device and a current position of the moving device; and outputting the management information acquired from each of the plurality of mobile terminals.

### Effect of the Invention

According to disclosure of the present invention, management efforts for sharing target objects that are shared and used by a plurality of user can be reduced.

### BRIEF DESCRIPTION OF THE DRAWINGS

FIG. 1 is a diagram illustrating an overview of a sharing management system according to this example embodiment.

FIG. 2 is a functional block diagram of the sharing management system according to this example embodiment.

FIG. 3 is a hardware configuration diagram of a sharing management device according to this example embodiment.

FIG. 4 is a functional block diagram of a sharing management device, a mobile terminal, and a base terminal according to this example embodiment.

FIG. 5 is a diagram illustrating a process flow of the sharing management device according to this example embodiment.

FIG. 6 is a diagram illustrating an example of the configuration of the sharing management device according to this example embodiment.

FIG. 7 is a diagram illustrating a process flow of the sharing management device illustrated in FIG. 6.

### EXAMPLE EMBODIMENT

Hereinafter, a sharing management system including a sharing management device according to an example embodiment of the present invention will be described with reference to the drawings.

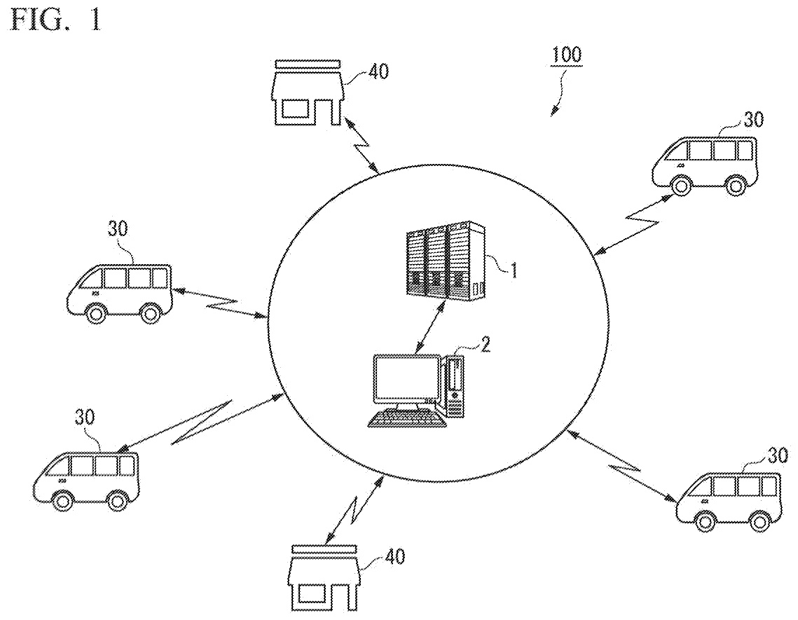

FIG. 1 is a diagram illustrating an overview of a sharing management system 100 according to an example embodiment of the present invention.

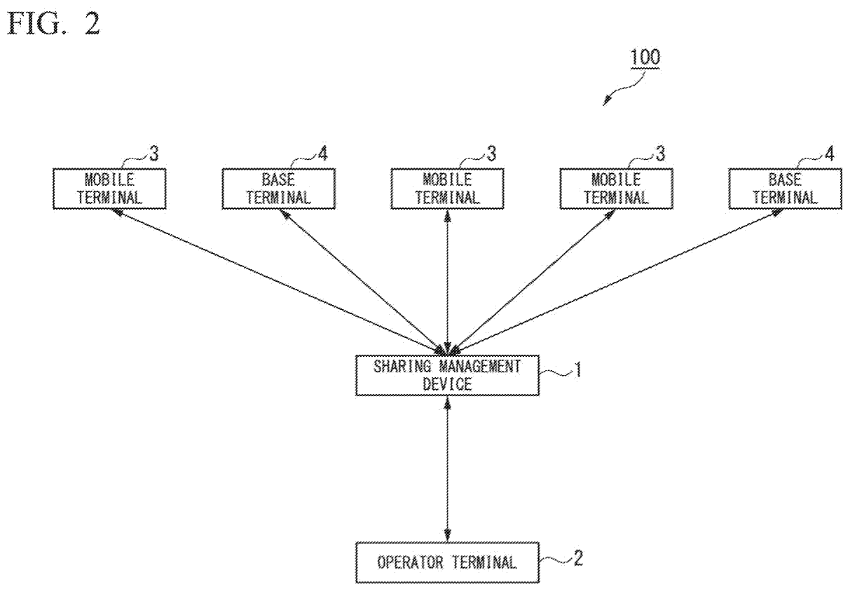

FIG. 2 is a functional block diagram of the sharing management system 100 according to an example embodiment of the present invention.

As illustrated in FIGS. 1 and 2, in the sharing management system 100, a sharing management device 1 and an operator terminal 2 are configured to be connected using a communication network. In addition, in the sharing management system 100, a mobile terminal 3 included in a moving device 30 and a base terminal 4 included at a store 40 of a storage base are configured to be communicatively connected to the sharing management device 1.

The operator terminal 2 is a terminal that is managed by an operator managing a sharing service. In this example embodiment, the operator, for example, performs a sharing service for renting sharing target objects (target objects) such as a wireless router, a communication device, a battery, a bicycle, an umbrella, and the like for a user. The operator stores one or a plurality of sharing target objects at storage places disposed in a taxi, a bus, and the like that are examples of the moving device 30. When a user gets in a moving device 30 such as a taxi or a bus, the user can rent these sharing target objects. In addition, a user can rent the sharing target objects also at a store 40 that is a storage base. After the use of a sharing target object stops, the user returns the sharing target object to a storage place of the moving device 30 or a store 40 that is a storage base. In a case in which a storage place for storing sharing target devices is provided in such a moving device 30, the sharing target objects stored in the moving device 30 also moves in accordance with movement of the moving device 30.

In a sharing service as described above, there are cases in which sharing target objects may accumulate unevenly at specific storage places. In such cases, an operator of the sharing service needs to move sharing target objects from a storage place or a storage base in which storage of sharing target objects is excessive to a storage place or a storage base in which the number of sharing target objects is insufficient. Much effort is expended for these movement operations.

In a sharing service described in this example embodiment, as described above, sharing target objects stored in a storage place of the moving device 30 are moved in accordance with movement of the moving device 30. Thus, even when sharing target objects stored in a moving device 30 is excessive, since this moving device 30 can be made to approach a storage place in which the number of sharing target objects is insufficient, movement from a storage place or a storage base in which sharing target objects is excessive to a storage place or a storage base in which sharing target objects are insufficient can be easily performed.

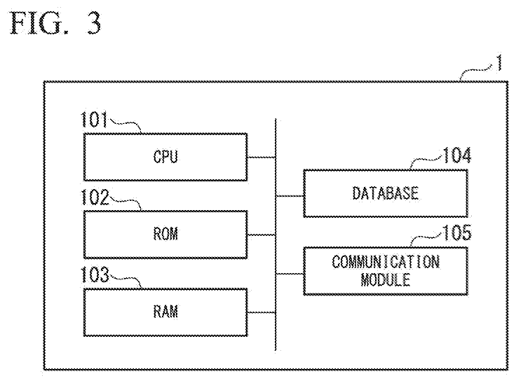

FIG. 3 is a hardware configuration diagram of the sharing management device 1.

As illustrated in FIG. 3, the sharing management device 1 is a computer that includes hardware such as a central processing unit (CPU) 101, a read only memory (ROM) 102, a random-access memory (RAM) 103, a database 104, and a communication module 105. The operator terminal 2, the mobile terminal 3, and the base terminal 4 are computers having hardware configurations similar thereto.

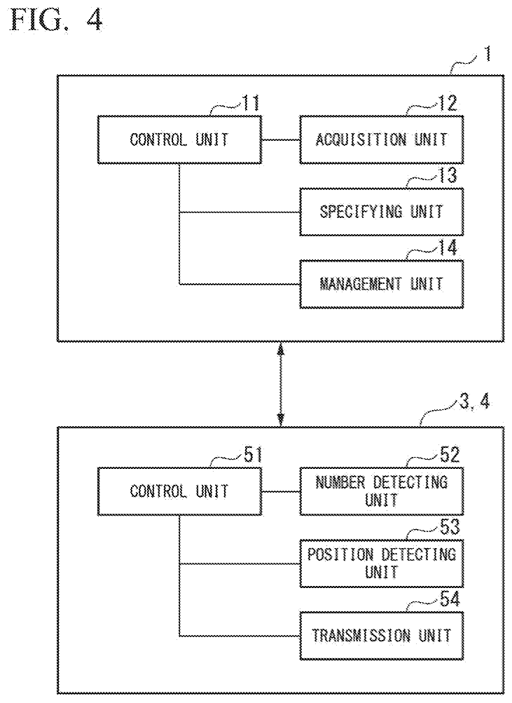

FIG. 4 is a functional block diagram of the sharing management device 1, the mobile terminal 3, and the base terminal 4.

When power is turned on, the sharing management device 1 operates and executes a sharing management program stored in advance. In accordance with this, the sharing management device 1 at least exhibits functions of a control unit 11, an acquisition unit 12, a specifying unit 13, and a management unit 14.

The control unit 11 controls other functional units.

The acquisition unit 12 acquires management information including the number of sharing target objects conveyed by the moving device 30 and the current position of the moving device 30 from the mobile terminal 3 mounted in the moving device 30 that conveys the sharing target objects. The acquisition unit 12 acquires the management information also from the base terminal 4 included in the store 40 of a storage base. The management information includes at least the number of sharing target objects stored in the store 40.

The specifying unit 13 specifies a moving device 30 (a first moving device) in which the number of sharing target objects that are conveyed (stored) is insufficient and a moving device 30 (a second moving device) in which the number of sharing target objects that are conveyed (stored) is excessive from a plurality of moving device 30.

The management unit 14 transmits management information including information acquired from other devices such as the mobile terminal 3 of the moving device 30 (the first moving device) in which the number of conveyed sharing target objects is insufficient, the mobile terminal 3 of the moving device 30 (the second moving device) in which the number of conveyed sharing target objects is excessive, the base terminal 4, and the like to the operator terminal 2 that is a transmission destination.

When power is turned on, the mobile terminal 3 and the base terminal 4 operate and execute a storage management program stored in advance. In accordance with this, the mobile terminal 3 and the base terminal 4 include a control unit 51, a number detecting unit 52, a position detecting unit 53, and a transmission unit 54.

The control unit 51 controls other functional units of the mobile terminal 3 or the base terminal 4.

The number detecting unit 52 detects the number of sharing target objects stored in a storage place or a storage area. More specifically, the number detecting unit 52 may count the number of management numbers of sharing target objects represented by information by reading the information from IC tags included in the sharing target objects positioned nearby and specify the number as the number of the sharing target objects. The number detecting unit 52 may acquire information of sharing target objects that are stored by detecting that a switch is turned on in a case in which a sharing target object is stored, detecting a signal transmitted in a case in which a sharing target object is stored, or the like and count the number.

The position detecting unit 53 detects a current position of the mobile terminal 3 (or the base terminal 4). The current position may be detected using a GPS function.

The transmission unit 54 transmits management information at least including the number of sharing target objects to the sharing management device 1. Alternatively, the transmission unit 54 transmits management information further including the current position to the sharing management device 1. The transmission unit 54 of the mobile terminal 3 may transmit management information with the current position stored therein. On the other hand, the transmission unit 54 of the base terminal 4 may not store the current position in the management information. In addition, the management information may further include an ID of the mobile terminal 3 (or the base terminal 4), an ID of the moving device 30 in which the mobile terminal 3 is installed, and an ID of the store 40 in which the base terminal 4 is installed.

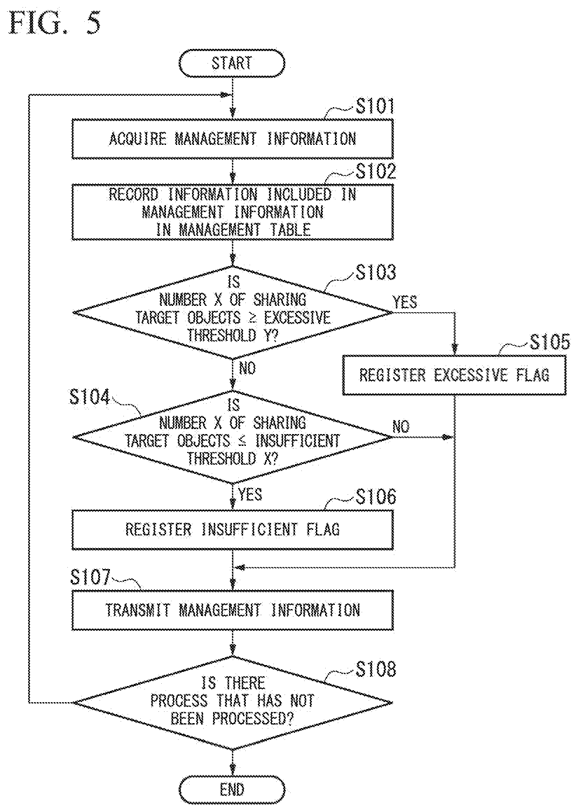

FIG. 5 is a diagram illustrating a process flow of the sharing management device 1.

Next, the process of each device of the sharing management system 100 will be described.

The number detecting unit 52 of the mobile terminal 3 included in the moving device 30 detects the number of sharing target objects stored in the moving device 30. In addition, the position detecting unit 53 of the mobile terminal 3 detects position information (latitude and longitude) of the moving device 30. Then, the transmission unit 54 of the mobile terminal 3 transmits the management information including the number of detected sharing target objects, the current position, the ID of the moving device 30, and the ID of the mobile terminal 3 to the sharing management device 1.

In addition, the number detecting unit 52 of the base terminal 4 included in the store 40 detects the number of sharing target objects stored in the store 40. The transmission unit 54 of the base terminal 4 transmits management information including the number of detected sharing target objects, the ID of the store 40, and the ID of the base terminal 4 to the sharing management device 1. In addition, although the position detecting unit 53 of the base terminal 4 may detect position information (latitude and longitude) of the store and add the detected position information to the management information, a general store 40 does not move, and thus the position information may not be detected.

The store 40 may be a moving-type store. In such a case, the position detecting unit 33 may detect the position information of the store. In a case in which the base terminal 4 does not detect position information, the sharing management device 1 records position information in a management table in association with the ID of the base terminal 4 or the store 40.

The acquisition unit 12 of the sharing management device 1 acquires the management information from the mobile terminal 3 or the base terminal 4 (Step S101). The acquisition unit 12 records the ID of the mobile terminal 3 or the base terminal 4, the ID of the moving device 30 or the ID of the store 40, the number of sharing target objects, and the current position included in the management information in the management table of the database 104 (Step S102). In a case in which an ID of the mobile terminal 3 or the base terminal 4 included in the management information is recorded in the management table in advance, the acquisition unit 12 may overwrite each piece of information included in the management information into each of pieces of information associated with the ID for update. Each time when the management information is received from each mobile terminal 3 or the base terminal 4, the acquisition unit 12 repeats a similar process.

The specifying unit 13 specifies moving devices 30 and stores 40 in which the number of sharing target objects that are being conveyed or stored is insufficient and moving devices 30 and stores 40 in which the number of sharing target objects that are being conveyed or stored is excessive on the basis of the management information acquired from the mobile terminal 3 and the base terminal 4. More specifically, the specifying unit 13 reads the number X of sharing target objects associated with ID of the mobile terminal 3 or the base terminal 4 from the management table and determines whether the number X is equal to or larger than an excessive threshold Y (X≥Y) (Step S103). In addition, the specifying unit 13 determines whether the number X is equal to or smaller than an insufficient threshold Z (X≤Z) (Step S104).

A relation of “excessive threshold Y>insufficient threshold Z” is formed. The excessive threshold Y and the insufficient threshold Z may be different between the moving device 30 and the store 40. In other words, in a case in which the number X of sharing target objects is recorded in the management table in association with the ID of the mobile terminal 3, the specifying unit 13 may determine whether the number X of the sharing target objects is excessive or insufficient using an excessive threshold Y or an insufficient threshold Z of the moving device 30. Alternatively, in a case in which the number X of sharing target objects is recorded in the management table in association with the ID of the base terminal 4, the specifying unit 13 may determine whether the number X of the sharing target objects is excessive or insufficient using an excessive threshold Y or an insufficient threshold Z of the store 40.

In a case in which the number X of the sharing target objects that are being conveyed or stored is equal to or larger than the excessive threshold Y (X≥Y), the specifying unit 13 determines that the number X of the sharing target objects that are being conveyed or stored is excessive and registers an excessive flag indicating excessive in the management table in association with the ID of the mobile terminal 3 or the base terminal 4 (Step S105). In a case in which the number X of the sharing target objects that are being conveyed or stored is equal to or smaller than the insufficient threshold Z (X≤Z), the specifying unit 13 determines that the number X of the sharing target objects that are being conveyed or stored is insufficient and registers an insufficient flag indicating insufficient in the management table in association with the ID of the mobile terminal 3 or the base terminal 4 (Step S106).

The management unit 14 reads the management information recorded in the management table in association with the ID of each mobile terminal 3 or the base terminal 4 and an excessive flag or an insufficient flag recorded in association with the ID for each predetermined period such as each interval of 30 minutes or the like. The management unit 14 transmits the management information including the excessive flag or the insufficient flag to all of the mobile terminals 3, the base terminals 4, and the operator terminal 2 (Step S107). The control unit 11 determines whether there is an ID, which has not been processed, among IDs of the mobile terminals 3 or the base terminals 4 (Step S108). In a case in which there is an ID that has not been processed, the control unit 11 instructs the specifying unit 13 to perform the process of specifying moving devices 30 and stores 40 in which the number of sharing target objects that are being conveyed or stored is insufficient and specifying moving devices 30 and stores 40 in which the number of sharing target objects that are being conveyed or stored is excessive.

The process described above is one example of a form in which the specifying unit 13 of the sharing management device 1 performs the process of specifying first moving devices 30 in which the number of conveyed sharing target objects is insufficient and second moving devices 30 in which the number of conveyed sharing target objects is excessive among the moving devices 30, and the management unit 14 of the sharing management device 1 performs a process of outputting the management information with IDs of the first moving devices and the second moving devices 30 added thereto.

In addition, the process described above is one example of a form in which the acquisition unit 12 of the sharing management device 1 performs the process of acquiring the number of sharing target objects stored in a storage base such as the store 40 in which a base terminal 4 is included from the base terminal 4 installed in the storage base of sharing target objects, the specifying unit 13 of the sharing management device 1 performs the process of specifying base terminals 4 of first bases in which the number of stored sharing target objects is insufficient and second bases in which the number of stored sharing target objects is excessive among a plurality of base terminals 4, and the management unit 14 performs the process of outputting management information with the IDs of base terminals of the first bases and the second bases further added thereto.

In accordance with this, the mobile terminal 3, the base terminal 4, and the operator terminal 2 can display the positions of other mobile terminals 3, the positions of the base terminals 4, a shortage or an excess of sharing target objects in the moving device 30 including the mobile terminal 3, and a shortage or an excess of sharing target objects in the store 40 including the base terminal 4 on a monitor or the like on the basis of the management information. In addition, a driver of the moving device 30 including the mobile terminal 3, a store clerk of the store 40 including the base terminal 4, and an operating staff operating the operator terminal 2 can perceive presence/absence of necessity of movement from the moving device 30 or the store 40 in which the sharing target objects are excessive to the moving device 30 or the store 40 in which the sharing target objects are insufficient.

The operating staff may convey the position of the moving device 30 or the position of the store 40 in which stored sharing target objects are insufficient to the driver of the moving device 30 or the store clerk of the store 40 in which stored sharing target objects are excessive and instruct them to give sharing target objects. Alternatively, the operating staff may convey the position of the moving device 30 or the position of the store 40 in which stored sharing target objects are excessive to the driver of the moving device 30 or the store clerk of the store 40 in which stored sharing target objects are insufficient and instruct them to receive sharing target objects.

Alternatively, the driver may check the positions of the other moving devices 30 and information of a shortage or an excess, or the positions of the store 40 and the information of a shortage or an excess, which are displayed on the mobile terminal 3, and move to the store by driving the moving device 30 to receive or deliver the sharing target objects.

In addition, in a case in which the excessive flag is recorded in association with the ID of the mobile terminal 3, the management unit 14 may generate map information indicating a movement path from the position of the moving device 30 in which the mobile terminal 3 is included to the store 40 in which the number X of stored sharing target objects is determined to be insufficient and add the map information to the management information. In this case, the management unit 14 determines whether the ID of the mobile terminal 3 and the excessive flag are included in the management information of a processing target. In a case in which the ID of the mobile terminal 3 and the excessive flag are included in the management information of the target (in the case of Yes), the management unit 14 reads an ID of the base terminal 4 that is closest to the position information of the mobile terminal 3 included in the management information and is associated with the insufficient flag (in other words, reads an ID of the base terminal 4 that is closest to the position information of the mobile terminal 3 included in the management information among IDs of the base terminals 4 associated with the insufficient flag). Then, the management unit 14 generates map information indicating a shortest path from the position of the mobile terminal 3 in which the number X of conveyed sharing target objects is excessive to the read position of the base terminal 4. For generation of the map information, a known technology may be used. Then, the management unit 14 adds the generated map information to the management information.

The management unit 14 transmits the generated management information to the mobile terminal 3 and the base terminal 4 included in the management information. When the management information is received, the mobile terminal 3 displays the map information included in the management information. The driver of the moving device 30 checks this map information and moves to a near store 40 in which sharing target objects are insufficient. The driver or the store clerk of the store 40 moves sharing target objects from the moving device 30 in which the number X of the stored sharing target objects is excessive to the store 40. In accordance with this, the moving device 30 such as a bus or a taxi conveys sharing target objects to the store 40 in which the number of stored target objects is insufficient, and thus efforts of a staff in charge of an operator of the sharing service for a work for collecting sharing target objects can be reduced.

Alternatively, in a case in which the insufficient flag is recorded in association with the ID of the mobile terminal 3, the management unit 14 may generate map information indicating a movement path from the position of the moving device 30 in which the mobile terminal 3 is included to the store 40 in which the number X of stored sharing target objects is determined to be excessive and add the map information to the management information. In this case, the management unit 14 determines whether the ID of the mobile terminal 3 and the insufficient flag are included in the management information of the processing target. In a case in which the ID of the mobile terminal 3 and the insufficient flag are included in the management information of the processing target (in the case of Yes), the management unit 14 reads the ID of the base terminal 4 that is closest to the position information of the mobile terminal 3 included in the management information and is associated with the excessive flag (in other words, the ID of the base terminal 4 that is closest to the position information of the mobile terminal 3 included in the management information among IDs of the base terminals 4 associated with the excessive flag is read).

Then, the management unit 14 generates map information indicating a shortest path from the position of the mobile terminal 3 in which the number X of conveyed sharing target objects is insufficient to the base terminal 4 (the store 40) associated with the read ID of the base terminal 4. For the generation of the map information, a known technology may be used. Then, the management unit 14 adds the generated map information to the management information.

The management unit 14 transmits the generated management information to the mobile terminal 3 and the base terminal 4 included in the management information. When the management information is received, the mobile terminal 3 displays the map information included in the management information. The driver of the moving device 30 checks this map information and moves to a near store 40 in which the sharing target objects are excessive. The driver or the store clerk of the store 40 loads sharing target objects from the store 40 in which the number X of stored sharing target objects is excessive into the moving device 30. In accordance with this, the moving device 30 such as a bus or a taxi conveys sharing target objects to the store 40 in which the number of stored sharing target objects is excessive, and thus efforts of a staff in charge of an operator of the sharing service for a work for supplying sharing target objects can be reduced.

In the process described above, a case in which the moving device 30 in which conveyed sharing target objects are excessive moves to the store 40 in which stored sharing target objects are insufficient or a case in which the moving device 30 in which conveyed sharing target objects are insufficient moves to the store 40 in which stored target objects are excessive have been described. However, the moving device 30 in which conveyed sharing target objects are excessive may move to another moving device 30 in which conveyed sharing target objects are insufficient, or the moving device 30 in which conveyed sharing target objects are insufficient may move to another moving device 30 in which stored sharing target objects are excessive.

In addition, in the description presented above, a case in which the moving device 30 is a bus or a taxi, and the store 40 is located at an arbitrary position in a town has been described. However, when the moving device 30 is an electric train, and the moving device 30 stops at a station that is a storage base, sharing target objects may be moved from an electric train in which the number of sharing target objects is excessive to a platform in which the number of sharing target objects is insufficient. Alternatively, when the moving device 30 is an electric train, and the moving device 30 stops at a station that is a storage base, sharing target objects may be moved from a platform in which the number of sharing target objects is excessive to an electric train in which the number of sharing target objects is insufficient.

In the process described above, in a case in which the moving device 30 moves to the store 40, the management unit 14 may calculate a fee to be paid to the driver of the moving device 30 or the manager of the moving device 30. For example, in a case in which the mobile terminal 3 or the base terminal 4 described above acquires an ID of a sharing target object and adds the acquired ID to the management information in association with the time, the management unit 14 of the sharing management device 1 specifies an ID of the mobile terminal 3 or the base terminal 4 included in the management table and determines whether IDs of sharing target objects associated with the ID or the number of the sharing target objects has increased or decreased from that of determination of the previous time. In a case in which the IDs or the number of sharing target objects has increased or decreased from that of the determination of the previous time, the management unit 14 specifies the ID of another mobile terminal 3 or the base terminal 4 recorded in the management table in association with the ID of the sharing target objects that has increased or decreased at the determination of the previous time. The management unit 14 determines whether or not the moving device 30 or the store 40 represented by the specified ID of the mobile terminal 3 or the base terminal 4 has approached, and, in a case in which the moving device 30 or the store 40 has approached, the management unit 14 determines that delivery/reception of the sharing target object between the moving device 30 and the store 40 has been performed. In this case, the management unit 14 performs the process of calculating a fee corresponding to a movement distance of the moving device 30 and assigning the amount of the fee to the driver or the manager of the moving device 30.

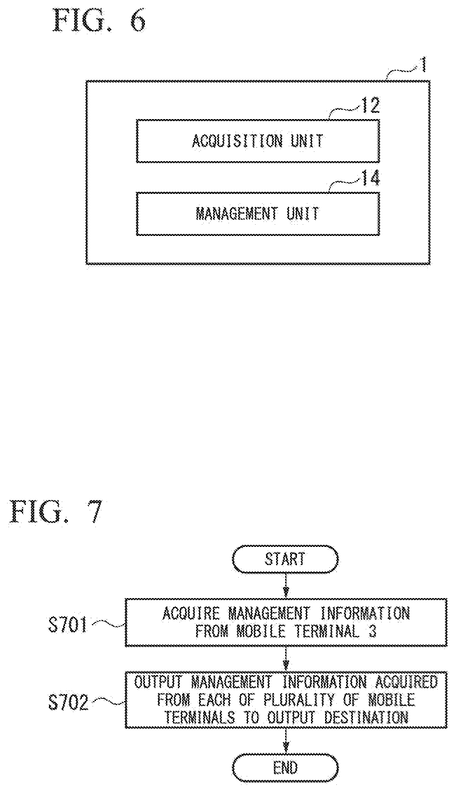

FIG. 6 is a diagram illustrating an example of the configuration of the sharing management device 1.

FIG. 7 is a diagram illustrating the process flow of the sharing management device illustrated in FIG. 6.

The sharing management device 1 at least includes an acquisition unit 12 and a management unit 14.

The acquisition unit 12 acquires, from the mobile terminal 3 mounted in the moving device 30 conveying sharing target objects that are shared and used by a plurality of users, management information including the number of sharing target objects conveyed by the moving device 30 and the current position of the moving device 30 (Step S701).

The management unit 14 outputs the management information acquired from each of a plurality of mobile terminals 3 (Step S701).

Each device described above includes a computer system therein. A procedure of each process described above is stored on a computer-readable recording medium in the form of a program, and the process described above is performed by a computer reading and executing this program. The “computer-readable recording medium” described here represents a magnetic disk, a magneto-optical disk, a CD-ROM, a DVD-ROM, a semiconductor memory, or the like. In addition, this computer program may be distributed to a computer through a communication line, and the computer that has received the distribution may execute the program.

The program described above may be used for realizing a part of the functions described above.

In addition, the program described above may be a program realizing the functions described above by being combined with a program recorded in the computer system in advance, that is, a so-called a differential file (differential program).

This application is based upon and claims the benefit of priority from Japanese patent application No. 2019-130014, filed Jul. 12, 2019, the disclosure of which is incorporated herein in its entirety by reference.

### INDUSTRIAL APPLICABILITY

The present invention may be applied to a sharing management device, a terminal, a sharing management method, and a recording medium.

### DESCRIPTION OF REFERENCE SYMBOLS

1 Sharing management device
2 Operator terminal
3 Mobile terminal
4 Base terminal
11 Control unit (control means)
12 Acquisition unit (acquisition means)
13 Specifying unit (specifying means)
14 Management unit (management means)
51 Control unit (control means)
52 Number detecting unit (number detecting means)
53 Position detecting unit (position detecting means)
54 Transmission unit (transmission means)
30 Moving device
40 Store

What is claimed is:

1. A sharing management device comprising:
at least one memory configured to store instructions; and
at least one processor configured to execute the instructions to:
acquire, from each of a plurality of mobile terminals respectively mounted in a plurality of moving devices conveying a sharing target object shared by a plurality of users, management information including number of the sharing target object being conveyed by the moving device and a current position of the moving device; and
output the management information acquired from each of the plurality of mobile terminals.

2. The sharing management device according to claim 1, wherein the at least one processor is configured to execute the instructions to:
specify, from the plurality of moving devices, a first moving device in which the number of the sharing target object that is being conveyed is insufficient and a second moving device in which the number of the sharing target object that is being conveyed is excessive; and
add identification information of the first moving device and the second moving device to the management information and output the management information.

3. The sharing management device according to claim 2, wherein the at least one processor is configured to execute the instructions to:
acquire, from each of a plurality of base terminals respectively installed in a plurality of storage bases, the number of the sharing target object stored in the storage base;
specify, from the plurality of storage bases, a first base in which the number of the stored sharing target object is insufficient and a second base in which the number of the stored sharing target object is excessive; and
further add identification information of the first base and the second base to the management information and output the management information.

4. The sharing management device according to claim 3, wherein the at least one processor is configured to execute the instructions to perform control of outputting a movement route from the first moving device or the second moving device to one of the plurality of storage bases.

5. The sharing management device according to claim 1, wherein the at least one processor is configured to execute the instructions to output the management information to a notification destination device.

6. A terminal for being mounted in a moving device, the moving device conveying a sharing target object shared by a plurality of users, the terminal comprising:
at least one memory configured to store instructions; and
at least one processor configured to execute the instructions to:
detect number of the sharing target object being conveyed by the moving device;
detect a current position of the moving device; and
transmit management information including the number of the sharing target object and the current position to a sharing management device.

7. A sharing management method comprising:
acquiring, from each of a plurality of mobile terminals respectively mounted in a plurality of moving devices conveying a sharing target object shared by a plurality of users, management information including number of the sharing target object being conveyed by the moving device and a current position of the moving device; and
outputting the management information acquired from each of the plurality of mobile terminals.

8. (canceled)
